(19) United States
(12) Patent Application Publication
(10) Pub. No.: US 2010/0108190 A1
(43) Pub. Date: May 6, 2010

(54) APPARATUS FOR THE RAPID FILLING OF COMPRESSED GAS CONTAINERS

(76) Inventors: Klaus Bäumer, Bonn (DE); Dirk Grulich, Siegburg (DE); Michael Rachner, Koln (DE); Norbert Scholz, Troisdorf (DE); Herbert Wiengand, Koln (DE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/443,841

(22) PCT Filed: Sep. 11, 2007
(86) PCT No.: PCT/EP2007/059522

§ 371 Date: Jan. 4, 2010

(30) Foreign Application Priority Data
Oct. 6, 2006 (DE) 10 2006 047 313.2

(51) Int. Cl. F17C 5/06

(52) U.S. Cl. 141/197

(57) ABSTRACT

The gas which is to be introduced into a compressed gas container (50) is stored in a storage container (10) at a high pressure of approximately 250 bar. A booster compressor (20) is connected downstream of the storage container: The outlet of the booster compressor can be connected to a pre-filling container (30) via a valve apparatus (22). The compressed gas container (50) is filled first of all by the pre-filling container (30). When the pressure of the latter is no longer sufficient, a switchover is carried out, wherein the further filling takes place by the booster compressor (20) via a cyclone tube (40) or an injection device. In this way, a large storage container can be filled in a short time.

The invention refers to an apparatus for the rapid filling of compressed-gas containers, said apparatus comprising a reservoir into which gas is introduced using a compressor, and particularly to an apparatus for the rapid transfer of large volumes of gas, such as natural gas, methane, nitrogen, oxygen, argon, air or hydrogen under high pressure, as is required in the rapid fueling of busses or municipal vehicles running on natural gas from a reservoir.

In gas fueling processes, such a volume of gas is to be filled into the compressed-gas container independent of the ambient temperature that—at a predetermined reference temperature—a limit value of the pressure, predetermined by technical regulations, is reached in the compressed-gas container, if possible. For example, according to technical regulations for compressed-gas containers holding natural gas, a pressure of 200 bar in the compressed-gas container at a reference temperature of 15° C. must not be exceeded. For a fast fueling operation by overflow, the reservoir must be under high pressure for the required mass of gas to be transferred into the compressed-gas container.

In gas fueling installations, the pressurizing work to be performed causes a heating of the gas in the compressed-gas container. The Joule-Thomson effect (a change in the gas temperature by throttling) of the real gas generally counteracts this heating. However, it is only under very favorable conditions, i.e. at sufficiently low temperatures, that the Joule-Thomson effect and the heat dissipation to the environment suffice to compensate for the heating caused by the pressurizing work of the gas. In gas fueling installations without a cooling device, if these favorable conditions do not exist, the compressed-gas container will be filled short upon rapid transfer. This is due to the fact that the pressurizing work creates a high temperature and thus a corresponding high pressure in the compressed-gas container, whereby the available pressure difference for filling is reduced to such an extent that the fueling operation takes a long time and is therefore terminated before the compressed-gas container holds the volume of gas possible according to technical specifications.

DE 197 05 601 A1 describes a natural gas fueling method without cooling of the gas, wherein the fueling of the compressed-gas container is continued until the pressure in the conduit to the compressed-gas container exceeds a maximum pressure. Another possibility provides that the fueling operation is terminated as soon as the mass flow falls below a limit value.

WO 97/06383 A1 describes a gas charging system for high-pressure gas bottles. Here, the gas is cooled by flushing the high-pressure gas bottle to be filled, whereby two connections for the feed and the return flow are needed. In the flushing circuit, the gas is cooled via a heat exchanger or by mixing it with gas in a reservoir.

EP 0 653 585 A1 describes a system for fueling a compressed-gas container. Here, a test pulse is performed, which is evaluated with reference to the thermal equation of state for the real gas. Further, a switching to reservoirs at higher pressures (multiple unit method) during the fueling is described. The fueling operation is performed intermittently. No cooling device is provided for the gas.

DE 102 18 678 A1 describes a method and a device, wherein the gas for filling the compressed-gas container is fed from a high-pressure reservoir through a cyclone tube acting as a cooling device. The cyclone tube takes advantage of the differential pressure prevailing in the fueling system to separate the gas flow into a hot gas flow and a cold gas flow. The latter is then supplied to the compressed-gas container. The functionality of this method is based on the fact that the gas is fed to a swirl generator at a supercritical pressure ratio, the generator being arranged axially between two pipes having different inlet diameters. A decrease in temperature through the use of a cyclone tube can be achieved if, and only if, supercritical pressure ratios exist. At a critical pressure ratio for natural gas of 1/π*=0.5427 and a pressure in the reservoir of pᵥ=250 bar, which is generally not reached, when a plurality of vehicles are refueled in short succession, a subcritical condition is obtained when the pressure in the compressed-gas container has risen to pₒ=135 bar. This means that, when filling a compressed-gas container with natural gas in a pressure range from pₒ=135 bar to pₒ=200 bar, the use of a cyclone tube will result in no further decrease in the gas temperature under the preconditions defined by the technical specifications.

WO 2006/04572 A1 addresses the problem of gas cooling after each stage of a membrane compressor using cyclone tubes. It becomes evident that the stage pressure ratio and/or the number of stages should be increased so as to be able to always operate the cyclone tubes at the supercritical pressure ratio. For this purpose, a pressure ratio of π=4 is insufficient in a four-stage membrane compressor if a pressure of p_{A}>250 bar is to be reached at the compressor outlet. When the pressure ratio is increased to π>4, the stage compression end temperature rises to a level that the use of a cyclone tube can lower to a temperature level that would be required for the economic operation of a membrane compressor.

WO 01/27475 A1 describes a multistage membrane compressor which, in a four stage design and at a stage pressure ratio π=4, can reach an output pressure p_{A}=256 bar at an intake pressure p_{E}=50 mbar. Because of its functioning, the membrane dimensions are limited so that also the maximum obtainable delivery volume is limited for the structure of the membrane compressor described in this patent.

DE 10 2006 010 325.2 is directed to a single- or multistage membrane pre-compressor and a downstream high pressure compressor of the membrane type for a gas fueling system, intended to increase the volume flow of the gas by at least a factor of 10 as compared to a membrane compressor of the conventional structure. When a compressor stage is divided into a plurality of membrane stages having the same dimensions in each stage, a very great volume flow can be compressed because of the pre-compressor. When the pre-compressor is equipped with more than one compressor stage, The pressure increase per stage can be lowered to a value between p=2.0 and p=2.5 not only in the pre-compressor but also in the high-pressure compressor arranged downstream thereof. Thereby, the gas temperature at the outlet of the pre-compressor and the high-pressure compressor can be kept low.

It is an object of the present invention to provide a device for the rapid filling of compressed-gas containers that allows to fill compressed-gas containers of large geometric volumes, as exist in busses or municipal vehicles running on natural gas, with highly compressed gas in a very short time so that a short filling of the compressed-gas container is avoided and an overfilling is excluded.

The device of the present invention is defined in claim 1. According thereto, it is provided that a booster compressor is arranged downstream of the reservoir to increase the pressure, that, via a valve device, the outlet of the booster compressor is selectively connectable to a pre-filling container or to a filling conduit leading to the compressed-gas container, that the outlet of the pre-filling container is connectable to the filling conduit, and that, when the pressure prevailing in the pre-filling container falls below a limit value, the filling conduit is switched over to the outlet of the booster compressor.

A booster compressor is a compressor used to increase the pressure of a gas stored in the reservoir during the withdrawal of the gas. In order to keep the compression heat generated during the withdrawal low in the booster compressor, the gas pressure at the inlet side of the booster compressor is set so high that the outlet pressure of the booster compressor is above the critical pressure of the compressed-gas container to be filled. In contrast to the filling of a compressed-gas container or another reservoir by overflow from a reservoir in which the gas pressure is limited according to the valid technical regulations for natural gas, these regulations do not apply to direct filling provided that the legal provisions for the compressed-gas container (200 bar at a reference temperature of 15° C.) and for the reservoir (250 bar at a reference temperature of 15° C.) are observed. The pressure ratio π generated in the booster compressor is low and is preferably below 1.5 so as to keep heating of the gas by the compression low immediately before the filling.

For filling a compressed-gas container, the gas is taken from a pre-filling container by overflow, which should have a gas pressure of approximately 250 bar at the beginning of the filling. Suitably, the latter container is not refilled during the overflow process. As soon as no supercritical pressure ratio can be maintained anymore during the overflow procedure between the supplying pre-filling container and the compressed-gas container to be filled and therefore the heating of the gas caused by the pressurizing work can no longer be compensated by the Joule-Thomson effect, the further filling of the compressed-gas container from the pre-filling container is aborted.

After the gas supply via the pre-filling container, a pressure increase is obtained by the booster compressor such that a critical pressure ratio between the gas at the booster outlet and the gas in the compressed gas container always prevails until the end of the filling process.

On the suction side, the booster compressor withdraws gas from a reservoir that is filled by a compressor to an end pressure of 250 bar, whether gas is withdrawn or not.

One embodiment of the invention uses a cyclone tube as a cooling device after the gas has exited the booster compressor. The cyclone tube uses the existing differential pressure of the gas in the filling system to separate the gas flow into a hot gas flow and a cold gas flow. The latter is supplied to the compressed-gas container. The cyclone tube is of a compact structure and includes no mobile parts. It is a cooling device, easy and economical to control, whose cooling effect is controlled by throttling the hot gas flow. Suitably, the hot gas flow is supplied to the pre-filling container from which the gas has been taken at the beginning of the compressed-gas container.

In a particular embodiment of the invention, as an alternative to the cyclone tube, the gas may also be introduced via an injection element situated in the compressed-gas container. In the injection element, designed as a bidirectional annular gap nozzle, the heating caused by the gas pressurizing work is completely or partly compensated for by adiabatic throttling depending on the pressure ratio between the inflowing gas and the gas in the compressed-gas container.

According to another advantageous embodiment of the invention, after the termination of the filling of the compressed-gas container, the pre-filling container from which the high-pressure gas has been taken at the beginning of the filling process, is filled up by the booster compressor to a pressure of 250 bar in a very short time, so that further filling processes can be performed in rapid succession in the manner described above.

The following is a detailed description of an embodiment of the invention with reference to the drawings.

### IN THE FIGURES

FIG. 1 is a cross section through a camshaft for controlling four membrane chambers of a booster compressor designed as a membrane pump,

FIG. 2 is a schematic general illustration of the gas filling system for the rapid transfer of large volumes of gas with a booster compressor of the membrane type, using a cyclone tube according to Ranque-Hilsch for decreasing the temperature of the gas after compression, the gas flow being separated in the cyclone tube into cold gas and hot gas,

FIG. 3 illustrates the same filling system as in FIG. 2, however, using a, injection element with a bidirectional annular gap nozzle in the compressed-gas container for the lowering of the gas temperature instead of a cyclone tube, and

FIG. 4 is a diagram showing the influence of the intake pressure at the booster compressor on the gas mass flow rate thereof.

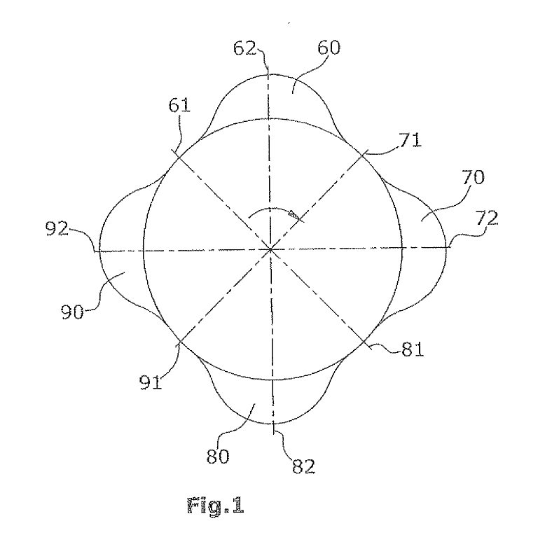

FIG. 1 is a cross section through the camshaft for controlling four membrane chambers with the profiles 60, 70, 80, 90 composed of circular arcs and straight lines, which profiles are offset from each other by 90° in the present case. In one rotation of the camshaft, all four membrane chambers are controlled successively according to the two-stroke cycle. At the points of contact 61, 71, 81, 91, the membrane chambers are expanded by means of the cam control. Thereafter, the predetermined profile of the cams up to the points of contact 62, 72, 82, 92 initiates a compression of the gas in the membrane chambers which is followed by an expulsion of the gas from the membrane chambers. The course of the expansion is predetermined by the profile of the camshaft between the contact points 62 and 71 for the first membrane chamber, 72 and 81 for the second membrane chamber, 82 and 91 for the third membrane chamber, as well as 92 and 61 for the fourth membrane chamber.

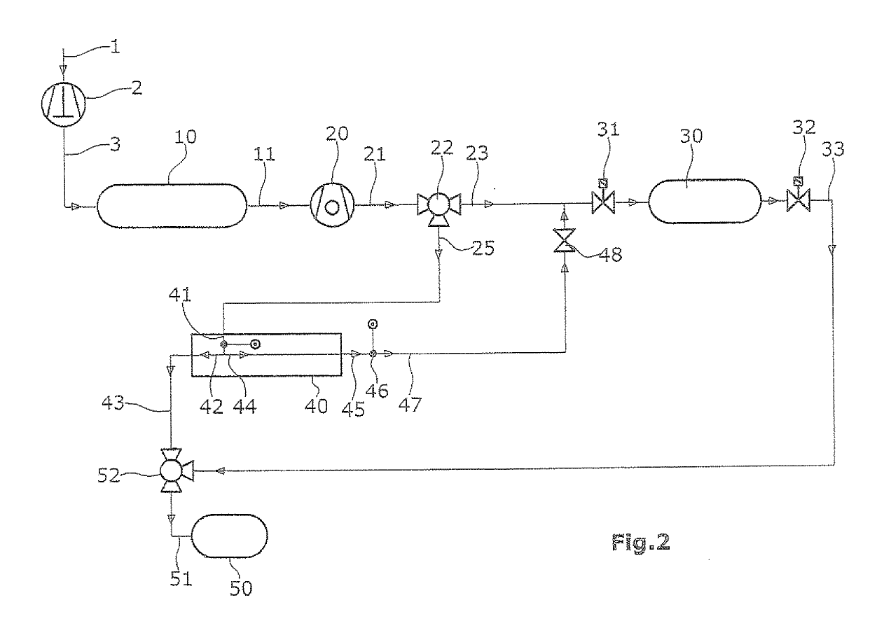

The gas filling system illustrated in FIG. 2 comprises a high-pressure compressor 2 with a feed line 1 and a take-off line 3 leading to the reservoir 10 that is filled to a maximum gas pressure of 250 bar by the high-pressure compressor 2. The outlet of the reservoir 10 is connected to the inlet of the booster compressor 20 via a take-off line 11, the booster compressor being designed as a single-stage membrane compressor. The outlet line 21 connects the booster compressor 20 to the three-way tap 22. Normally, the three-way tap 22 is set such that the gas flow is introduced from the take-off line 21 into the feed line 23 and via the open magnet valve 31 into the pre-filling container 30 with the magnet valve 32 on the outlet side being closed. When a gas pressure of 250 bar is reached in the pre-filling container 30, the booster compressor 20 is switched off and the magnet valve 31 is closed.

The opening of the magnet valve 32 marks the start of the filling process by the overflow of the gas from the pre-filling tank 30 into the compressed-gas container 50 via the take-off line 33 and the three-way tap 52 which, at the beginning of the filling is set such that the three-way tap 52 connects the take-off line 33 with the filling line 51 of the compressed-gas container 50. If, during the overflow of the gas from the pre-filling container 30 into the compressed-gas container 50, the critical pressure ratio 1/π*=p_{D}/p_{V}>(2/K+1)^{k/K-1}, formed by the pressure p_{V} measured in the pre-filling container and the pressure p_{D} measured in the compressed-gas container 50, becomes subcritical, the magnetic valve 32 is closed, the booster compressor 20 is activated and the actual setting of the three-way taps 22 and 52 is changed by a switching operation, all at the same time. Here, K is the adiabatic exponent of the compressed gas, i.e. a specific gas constant. For natural gas, this is 1.317. p_{D} is the pressure in the compressed-gas container 50 to be filled and P_{V} is the pressure in the reservoir 10.

Thus, the take-off line of the booster compressor 20 is connected with the feed line 25 of the cyclone tube 40 via the three-way tap 22. Generally, the cyclone tube is designed such as described in DE 102 18 678 A1, so that a detailed description of the structure of the cyclone tube can be omitted. The cyclone tube serves to lower the gas temperature after the previous compression.

The cyclone tube 40, operating according to the counter flow method, is connected with the booster compressor 20 via the feed line 25. Via the feed line 25, the gas flow reaches the inflow nozzle 41 that forms the narrowest cross section flown through between the booster outlet and the compressed-gas container 50. From the inflow nozzle 41, the gas arrives in the central tube of the cyclone tube 40 as a swirl flow at the speed of sound, a separation into a cold outlet 42 and a hot outlet 44 taking place in the central tube. At one end of the central tube, the cold core of the swirl forming is taken off as a cold gas flow 42 and guided through the take-off line 43 to the three-way tap 52 and via the filling line 51 to the compressed-gas container 50. At the opposite end of the central tube, the hot gas flow 44 is taken off and discharged via the pipe line 45. The throttle point 46 in the pipe line 45 serves the pre-setting of the mass ratio of the cold and hot gas portions.

Downstream of the throttle point 46, the hot gas flow reaches the pre-filling container 30 via the return line 47 and the feed line 23, with the magnetic valve 31 open and the magnetic valve 32 closed, the hot gas flow mixing with the gas present in the container and being stored therein. The check valve 48 in the return line 47 prevents gas from flowing into the return line 47 of the hot gas flow when the pre-filling container 30 is filled.

After the termination of the process of filling the compressed-gas container 50, the three-way tap 22 in the take-off line 21 of the booster compressor 20 is switched to the feed line 23 to the pre-filling container 30 so that, with the magnetic valve 31 open and the magnetic valve 32 in the take-off line 33 closed, the pre-filling container can be filled until a pressure of 250 bar is reached. The reservoir 10 has a larger geometric volume than the pre-filling container 30 so that after a filling process, the latter can be refilled rapidly by the booster compressor 20 to the allowed end pressure of 250 bar.

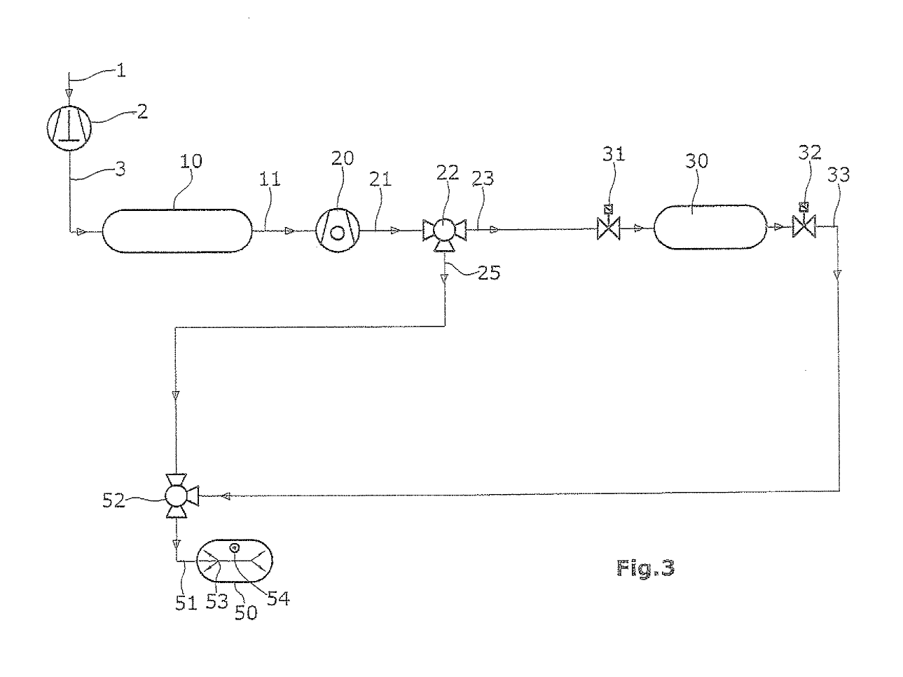

Compared to the system illustrated in FIG. 2, the gas filling system illustrated in FIG. 3 has an injection element 53 in the compressed-gas container 50, provided for gas cooling purposes instead of the cyclone tube 40, so that by adiabatic throttling and the Joule-Thomson effect, a cooling of the gas is achieved after a previous heating due to the compression work, without any heat exchange with the environment. Thus, the omission of the cyclone tube 40 entails the omission of the return line 43 for the cold gas and the return line 47 with the check valve 48 for the hot gas.

In this gas filling system, the feed line 25 is connected with the three-way tap 52. As soon as a subcritical pressure ratio is obtained during the filling between the pre-filling container 30 and the compressed-gas container 50, the magnetic valve 32 is closed, the booster compressor 20 is activated and the given setting of the three-way taps 22 and 52 is changed by a switching operation so that the gas flow is directed from the outlet line 21 into the feed line 25 to eventually reach the filling line 51 via the three-way tap 52. The gas flow is supplied to the injection element 53 via the filling line 51.

The injection element 53 is designed as described in DE 100 31 155 C2 so that a detailed explanation of the injection element can be omitted. The injection element serves to lower the gas temperature after the previous heating by the compression work and to rapidly introduce gas in a manner preventing damage to the container wall of the compressed-gas container 50.

The injection element 53 equipped with bidirectional annular gap nozzles has its narrowest cross section 54 in the annular gap. In gas jet exiting from an annular gap, a jet surface is created that is a multiple of the surface of a gas jet exiting from a bore of the same surface area having a circular cross section. The large surface of the gas jet flowing from an annular gap into the compressed-gas container 50 causes a particularly rapid mixing thereof with the residual gas volume in the container. Thus local temperature peaks at the container wall caused by the gas flow are avoided that would otherwise occur during the non-stationary filling process. After the end of the filling, a rapid temperature compensation is achieved due to the good mixing.

Due to the fact that the injection element 53 with its critical cross section 54 is situated within the compressed-gas container 50, adiabatic throttling and the Joule-Thomson effect cause a cooling of the gas after the previous heating by the compression work, and at the same time that the magnetic valve 32 of the take-off line 33 is closed, the booster compressor 20 is started and its take-off line 21 is switched to the line 25 of the three-way tap 52 via the three-way tap 22. Thus, by switching, the three-way tap 52 establishes the connection with the filling line 51 that fills the compressed-gas container 50.

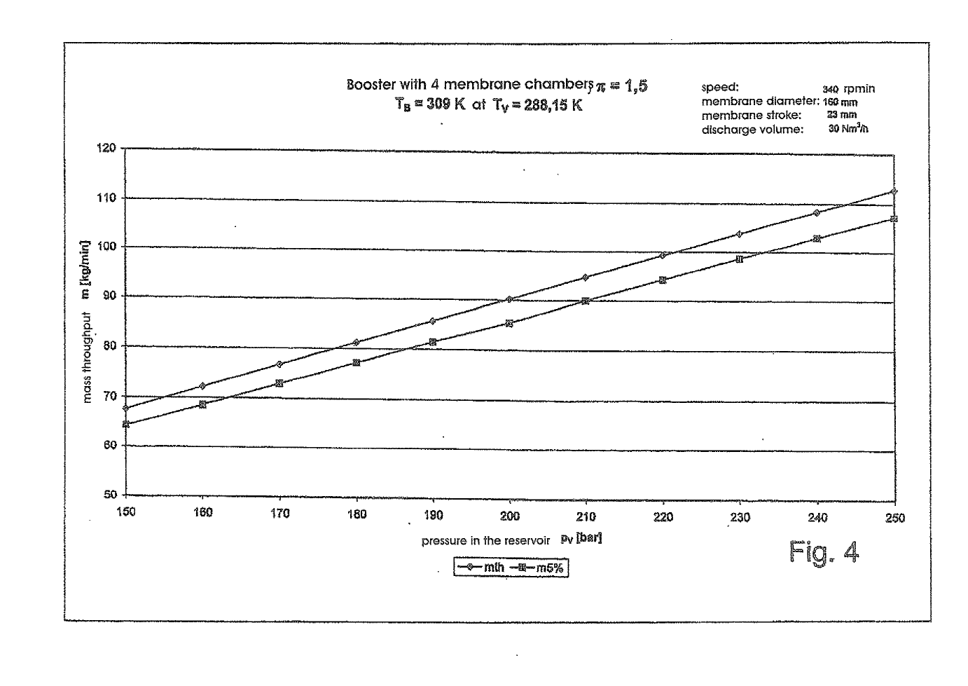

The diagram p_{V}=f (m) illustrated in FIG. 4 shows the influence of the pressure p_{V} in the reservoir 10 on the mass throughput m of the booster compressor 20 for the design data of the booster compressor indicated in the heading of the diagram. Here, the straight line p_{V}=f (mₜₕ) represents values calculated in a loss-free manner and the straight line p_{V}=f (m_{5%}) represents values calculated with an assumed total loss of 5% in the booster compressor 20.

1. An apparatus for the rapid filling of compressed-gas containers (50), comprising a reservoir (10) into which gas is introduced by a compressor (2), characterized in that a booster compressor (20) for increasing the pressure is connected downstream of the reservoir (10); the outlet of the booster compressor (20) can be selectively connected—via a first valve device (22)—to a pre-filling container (30) or to a filling line (51) leading to the compressed-gas container (50); the outlet of the pre-filling container (30) can be connected to the filling line (51); and, when the pressure in the pre-filling container falls below a limit value, the filling line (51) is switched to the outlet of the booster compressor (20).

2. The apparatus of claim 1, characterized in that a cyclone tube (40) is connected between the outlet of the booster compressor (20) and the filling line (51), the cold outlet (42) of the tube being connectable to the filling line (51) and the warm outlet (44) being connectable to the inlet of the pre-filling container (30).

3. The apparatus of clam 1, characterized in that an injection element (53) is connected to the filling line (51).

4. The apparatus of claim 1, characterized in that the booster compressor (20) has a lower pressure ratio of π<1.5 so that upon a slight heating of the gas a large mass flow is rapidly brought to a higher pressure level.

5. The apparatus of claim 4, characterized in that the single-stage booster compressor (20) comprises at least two membrane chambers compressing in parallel.

6. The apparatus of claim 5, characterized in that at least two membrane chambers are arranged in a star shape around a camshaft which is designed such that in one rotation of the camshaft a compression and an expansion of the gas flow takes place successively in all membrane chambers.

7. The apparatus of claim 6, characterized in that, when more than four membrane chambers are provided, these are configured as a double- or multi-star arrangement around the camshaft.

8. The apparatus of claim 1, characterized in that, at the beginning of a filling process, the gas at a pressure of approximately 250 bar is supplied from the pre-filling container (30), whose feed line (23) is closed by a magnetic valve (31), to the feed line (51) via a take-off line (33).

9. The apparatus of claim 8, characterized in that the filling of the compressed-gas container (50) from the pre-filling container (30) is aborted by closing a magnetic valve (32) in the take-off line (33) in the event that the critical pressure ratio 1/π*=p_{D}/p_{V}>(2/K+1)^{k/K-1} between the filling container and the container to be filled becomes subcritical 1/π*=p_{D}/p_{V}>(2/K+1)^{k/K-1} during the overflow from the pre-filling container (30) into the compressed-gas container (50), which ratio is formed from the pressure (p_{D}) measured in the compressed-gas container and the pressure (p_{V}) measured in the pre-filling container, where k is the adiabatic exponent of the gas.

10. The apparatus of claim 1, characterized in that simultaneous with the closing of a magnetic valve (32) in the take-off line (33) of the pre-filling container (30), the booster compressor (20) is started and the take-off line (21) thereof is switched to the feed line (25) of a cyclone tube (40) by means of a three-way tap (22) and the cold gas flow (43) is connected to the filling line (51) of the compressed-gas container (50) via another three-way tap (52), and the compressed-gas container is continued to be filled from the reservoir (10) via the booster compressor (20) in order to increase the pressure and via the cyclone tube (40) to cool the gas, until a predetermined pressure is reached in the compressed-gas container at a reference temperature.

11. The apparatus of claim 8, characterized in that after the end of the filling of the compressed-gas container (50), the filling device (22) in the take-off line (21) of the booster compressor (20) is switched to the pre-filling container (30).
